(19) United States
(12) Patent Application Publication
(10) Pub. No.: US 2026/0290077 A1
(43) Pub. Date: Sep. 24, 2026

(54) GAZE PREDICTION MODEL CONSTRUCTION METHOD AND APPARATUS, GAZE PREDICTION METHOD AND APPARATUS, ELECTRONIC DEVICE, AND STORAGE MEDIUM

(71) Applicant: Beijing Zitiao Network Technology Co., Ltd., Beijing (CN)

(72) Inventor: Liangliang WANG, Beijing (CN)

(21) Appl. No.: 19/490,848

(22) PCT Filed: May 31, 2024
(86) PCT No.: PCT/CN2024/096691

§ 371 Date: Dec. 5, 2025

(30) Foreign Application Priority Data
Jun. 7, 2023 (CN) 202310668262.4

(51) Int. Cl. G06V 40/18; G06V 10/774; G06V 10/778

(52) U.S. Cl. CPC G06V 40/193; G06V 10/774; G06V 10/7792

(57) ABSTRACT

The present disclosure provides a gaze prediction model construction method and apparatus, a gaze prediction method and apparatus, an electronic device, and a storage medium. The gaze prediction model construction method comprises: inputting a first eye sample image and a second eye sample image into an assisted prediction model to obtain gaze difference description information; inputting the first eye sample image and the second eye sample image into a gaze prediction model to be constructed to obtain predicted gaze information; and if the loss of said gaze prediction model determined on the basis of the gaze difference description information and the predicted gaze information does not meet a convergence condition, updating a model parameter of said gaze prediction model on the basis of the gaze difference description information and the predicted gaze information, otherwise, determining said gaze prediction model to be a gaze prediction model.

### CROSS-REFERENCE TO RELATED APPLICATIONS

The present application is based on and claims priority to Chinese Patent Application No. 202310668262.4, and filed on Jun. 7, 2023, the entire disclosure of the Chinese Patent Application is hereby incorporated by reference in its entirety.

### TECHNICAL FIELD

The present disclosure relates to the field of computer technology, and in particular to a gaze prediction model construction method, a gaze prediction method, apparatus, an electronic device, and a storage medium.

### BACKGROUND

With rapid development of computer vision, artificial intelligence and other fields, the research on gaze estimation technology has attracted widespread attention. Gaze estimation plays an important role in many research fields, such as human-computer interaction, virtual reality, social interaction analysis, and medical treatment.

### SUMMARY

According to one aspect of the present disclosure, there is provided a method for constructing a gaze prediction model, comprising:
inputting a first eye sample image and a second eye sample image into an auxiliary prediction model to obtain gaze difference description information, wherein the gaze difference description information is configured to represent a gaze difference between the first eye sample image and the second eye sample image;
inputting the first eye sample image and the second eye sample image into the gaze prediction model to be constructed to obtain predicted gaze information, where the predicted gaze information includes a first predicted gaze parameter of the first eye sample image and a second predicted gaze parameter of the second eye sample image;
determining a loss of the gaze prediction model to be constructed based on the gaze difference description information and the predicted gaze information;
in response to that the loss of the gaze prediction model to be constructed does not meet a convergence condition, updating model parameters of the gaze prediction model to be constructed based on the gaze difference description information and the predicted gaze information; and/or, in response to that the loss of the gaze prediction model to be constructed meets the convergence condition, determining the gaze prediction model to be constructed as the gaze prediction model.

According to another aspect of the present disclosure, there is provided a gaze prediction method, comprising:
acquiring a target eye image;
inputting the target eye image into a gaze prediction model to obtain a gaze parameter corresponding to the target eye image, wherein the gaze prediction model is obtained by the method of constructing a gaze prediction model described in exemplary embodiments of the present disclosure.

According to another aspect of the present disclosure, there is provided an apparatus for constructing a gaze prediction model, comprising:
a training module, configured to input a first eye sample image and a second eye sample image into an auxiliary prediction model to obtain gaze difference description information, wherein the gaze difference description information is configured to represent a gaze difference between the first eye sample image and the second eye sample image; input the first eye sample image and the second eye sample image into the gaze prediction model to be constructed to obtain predicted gaze information, where the predicted gaze information includes a first predicted gaze parameter of the first eye sample image and a second predicted gaze parameter of the second eye sample image; determine a loss of the gaze prediction model to be constructed based on the gaze difference description information and the predicted gaze information; in response to that the loss of the gaze prediction model to be constructed does not meet a convergence condition, update model parameters of the gaze prediction model to be constructed based on the gaze difference description information and the predicted gaze information; and
a determination module, configured to, in response to that the loss of the gaze prediction model to be constructed meets the convergence condition, determine the gaze prediction model to be constructed as the gaze prediction model.

According to yet another aspect of the present disclosure, there is provided a gaze prediction device apparatus, comprising:
an acquisition module, configured to acquire a target eye image;
a prediction module, configured to input the target eye image into a gaze prediction model to obtain a gaze parameter corresponding to the target eye image, wherein the gaze prediction model is obtained by the apparatus for constructing a gaze prediction model described in exemplary embodiments of the present disclosure.

According to yet another aspect of the present disclosure, there is provided an electronic device, comprising: a processor; and a memory having a computer program and/or instructions stored thereon, wherein the program and/or instructions, when executed by the processor, cause the processor to implement the method as described in exemplary embodiments of the present disclosure.

According to yet another aspect of the present disclosure, there is provided a non-transitory computer-readable storage medium having thereon stored computer instructions, which, when executed by a computer, cause the computer to implement the method as described in exemplary embodiments of the present disclosure.

According to yet another aspect of the present disclosure, there is provided a computer program product containing instructions and/or computer programs, which, when executed by a processor, cause implementation of the method as described in exemplary embodiments of the present disclosure.

According to yet another aspect of the present disclosure, there is provided a computer program containing computer programs, which, when executed by a processor, cause implementation of the method as described in exemplary embodiments of the present disclosure.

### BRIEF DESCRIPTION OF THE DRAWINGS

Further details, features and advantages of the present disclosure are disclosed in the following description of exemplary embodiments in conjunction with the accompanying drawings, in which:

FIG. 1 shows a flow chart of a method for constructing a gaze prediction model according to an exemplary embodiment of the present disclosure;

FIG. 2 shows a schematic diagram of a model architecture of an exemplary embodiment of the present disclosure;

FIG. 3 shows a flow chart of a gaze prediction method according to an exemplary embodiment of the present disclosure;

FIG. 4 shows a schematic block diagram of modules of an apparatus for constructing a gaze prediction model according to an exemplary embodiment of the present disclosure;

FIG. 5 shows a schematic block diagram of modules of a gaze prediction apparatus according to an exemplary embodiment of the present disclosure;

FIG. 6 shows a schematic block diagram of a chip according to an exemplary embodiment of the present disclosure;

FIG. 7 shows a block diagram of an exemplary electronic device that can be used to implement the embodiments of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be embodied in various forms and should not be construed as being limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method embodiments of the present disclosure may be performed in a different order and/or in parallel. Furthermore, method embodiments may include additional steps and/or omit performing the illustrated steps. The scope of the present disclosure is not limited in this respect.

As used herein, the term “including” and its variants are open-ended including, that is, “including but not limited to”. The term “based on” is “at least partially based on”; the term “one embodiment” means “at least one embodiment”; the term “another embodiment” means “at least one other embodiment”; the term “some embodiments” means “at least some embodiments”. Related definitions of other terms will be given in the following description. It should be noted that the concepts of “first” and “second” mentioned in the present disclosure are only used to distinguish different apparatuses, modules or units, and are not used to limit the order or interdependence of the functions performed by these apparatuses, modules or units.

It should be noted that the modifications of “a” and “a plurality” mentioned in the present disclosure are schematic rather than limiting, and those skilled in the art should understand that unless the context clearly indicates otherwise, they should be understood as “one or more”.

Names of messages or information exchanged between multiple apparatuses in the embodiments of the present disclosure are only for illustrative purposes, and are not intended to limit the scope of these messages or information.

The exemplary embodiments of the present disclosure provide a method for constructing a gaze prediction model, a gaze prediction method, apparatuses, an electronic device and a storage medium. In particular, gaze difference description information output by an auxiliary prediction model is utilized in constructing the gaze prediction model, for example, it is used as supervision information for eye sample image pairs, so as to achieve advantageous technical effects, for example, including but not limited to at least one of the following: on the one hand, the cost of annotating samples can be reduced; on the other hand, the gaze deviation caused by individual differences such as the angle between the visual axis and the optical axis of the eye can be eliminated, thereby avoiding overfitting caused by “sample data discreteness” during the acquisition of eye sample image pairs. Additionally or alternatively, the gaze prediction model obtained according to embodiments of the present disclosure can be directly used to predict the gaze direction corresponding to the eye image to be tested during an inference stage, without needing to collect a calibration image first for calibration.

The method of exemplary embodiments of the present disclosure may be executed by an electronic device, or may be executed by a chip applied to the electronic device.

Exemplarily, the electronic device of exemplary embodiments of the present disclosure may be an electronic device with a display function, where the electronic device may be a mobile phone, a tablet computer, a wearable device, a vehicle-mounted device, a laptop computer, an ultra-mobile personal computer (UMPC), a netbook, or other terminals.

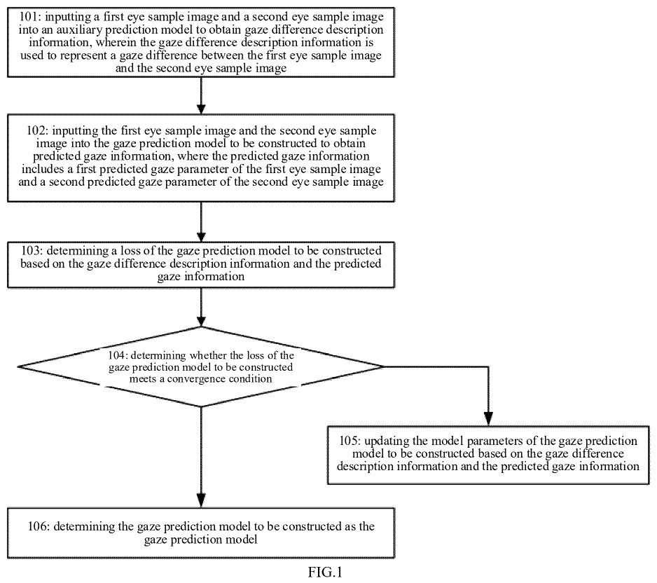

FIG. 1 shows a flow chart of a method of constructing a gaze prediction model according to an exemplary embodiment of the present disclosure. As shown in FIG. 1, a method of constructing a gaze prediction model according to an exemplary embodiment of the present disclosure may include:

Step 101: inputting a first eye sample image and a second eye sample image into an auxiliary prediction model to obtain gaze difference description information, wherein the gaze difference description information is used to represent a gaze difference between the first eye sample image and the second eye sample image. The above-mentioned first eye sample image and second eye sample image may be two eye images belonging to the same object. For a single eye image, it can be a monocular image or a binocular image, here, the binocular image can be a concatenated image formed by left and right eye images from the same object collected at the same time, or it can be a binocular image of the same object collected at the same time. For multiple eye images, they can be collected at the same time or at different times, which can be determined according to the actual scenarios and will not be limited here.

When the first eye sample image and the second eye sample image are input into the auxiliary prediction model, the auxiliary prediction model can process the first eye sample image and the second eye sample image in a manner of weight sharing, that is, the auxiliary prediction model can use the same weight for processing the first eye sample image and the second eye sample image.

Assuming that an eye gaze direction in the first eye sample image is defined as a first gaze direction, and an eye gaze direction in the second eye sample image is defined as a second gaze direction, an exemplary embodiment of the present disclosure can use the auxiliary prediction model to output gaze difference description information for the first eye sample image and the second eye sample image, and the gaze difference description information can be used to represent the gaze difference between the first gaze direction and the second gaze direction.

The auxiliary prediction model may be an untrained neural network model, an incompletely trained neural network model, or a pre-trained neural network model. Exemplarily, when the above-mentioned auxiliary prediction model is a pre-trained neural network model, the exemplary embodiments of the present disclosure may use two accurately labeled eye images and corresponding two labeled gaze directions as training samples, determine the loss based on a predicted value of the gaze difference between the two eye images output by the neural network model during the training process and a true value of the gaze difference determined by the two labeled gaze directions, and when it is determined that the currently trained neural network model converges based on the loss, determine that the currently trained neural network model is the auxiliary prediction model. After the training of the auxiliary prediction model is completed, the auxiliary prediction model can be configured to predict the gaze difference description information corresponding to the first eye sample image and the second eye sample image.

Step 102: inputting the first eye sample image and the second eye sample image into the gaze prediction model to be constructed to obtain predicted gaze information, where the predicted gaze information includes a first predicted gaze parameter of the first eye sample image and a second predicted gaze parameter of the second eye sample image.

When the first eye sample image and the second eye sample image are input into the gaze prediction model to be constructed, the processing weights for the first eye sample image and the second eye sample image by the prediction model to be constructed are consistent, so that the prediction model to be constructed can process the first eye sample image and the second eye sample image in a manner of weight sharing, thereby obtaining the first predicted gaze parameter and the second predicted gaze parameter.

Exemplarily, in the exemplary embodiments of the present disclosure, the first eye sample image and the second eye sample image may be concurrently input into the gaze prediction model to be constructed, or may be separately input into the gaze prediction model to be constructed. The gaze prediction model to be constructed can output the first predicted gaze parameter based on the first eye sample image, and output the second predicted gaze parameter based on the second eye sample image. Here, the first predicted gaze parameter can be used to represent prediction result of the eye gaze direction in the first eye sample image, and the second predicted gaze parameter can be used to represent prediction result of the eye gaze direction in the second eye sample image.

Step 103: determining a loss of the gaze prediction model to be constructed based on the gaze difference description information and the predicted gaze information.

In the related art, a gaze estimation model is often trained by using eye images with annotated gaze directions, and then the eye image to be tested is directly input into the trained gaze estimation model to determine the gaze direction of the eye image to be tested; and when the gaze estimation model is trained, the loss is usually determined based on the prediction value of the gaze estimation model and the annotated gaze direction of the eye image. However, in practice, there are relatively few eye images with precise annotations, and, due to the differences in the angles between the visual axes and the optical axes of different individuals, the gaze estimation model trained by using limited eye images with precise annotations, during its inference phase, may cause that the gaze direction determined by the gaze estimation model often has gaze estimation deviation caused by individual differences, when the eye images to be tested obtained by the gaze estimation model belong to different object individuals from the sample images processed by the gaze estimation model in the training phase. In addition, since the training sample set of eye images with precise annotations usually have the problem of “data discreteness”, if the loss is determined only based on the prediction value of the gaze estimation model and the annotated gaze direction of the eye image, it is liable to cause the gaze estimation model to overfit during the training process.

The method of the exemplary embodiment of the present disclosure uses the gaze difference description information output by the auxiliary prediction model as the supervision information for the eye sample images to achieve advantageous technical effects, such as including, but not limited to, at least one of the following: on the one hand, the cost of annotating samples can be reduced; on the other hand, the gaze difference prediction model can learn the information about gaze difference between the first eye sample image and the second eye sample image during the training process; due to the data composition characteristics of the gaze difference information per se which can eliminate the aforementioned prediction deviation introduced by the individual differences, the gaze difference prediction model constructed thereby, when predicting the gaze, can avoid the problem of inaccurate gaze direction prediction caused by individual differences. In addition, by supervising the training process of the gaze prediction model through the gaze difference description information output by the auxiliary prediction model, the model overfitting problem caused by the “data discreteness” of the training data set of eye sample images can also be avoided.

Exemplarily, the loss of the gaze prediction model to be constructed in the exemplary embodiments of the present disclosure may include at least a first loss parameter, and the first loss parameter may be determined based on the first predicted gaze parameter, the second predicted gaze parameter and the supervision information for eye sample images. When the gaze difference description parameter of the exemplary embodiments of the present disclosure may include at least a reference gaze difference parameter, the above-mentioned supervision information for eye sample images may include the reference gaze difference parameter, the above-mentioned first loss parameter may include a first sub-loss parameter, the first sub-loss parameter may be determined based on the reference gaze difference parameter and a gaze difference parameter, where the gaze difference parameter may be determined by the difference between the first predicted gaze parameter and the second predicted gaze parameter.

The above-mentioned reference gaze difference parameter may essentially be the difference between a first gaze direction determined by the first eye sample image and a second gaze direction determined by the second eye sample image, of course, it may also be a relevant parameter used to represent the gaze direction difference, for example, the gaze direction may be defined by a gaze angle.

For example, assuming that the eye sight when the eyes are looking straight ahead serves as a reference gaze, based on the reference gaze, the angles between other eye gaze directions and the reference gaze are defined as other eye gaze angles. Based on this, an exemplary embodiment of the present disclosure can define a first gaze direction determined from a first eye sample image through a first gaze angle, define a second gaze direction determined from a second eye sample image through a second gaze angle, and then determine a gaze angle difference through the first gaze angle and the second gaze angle, and define the gaze angle difference as a relevant parameter of the gaze direction difference.

When the supervision information for eye sample images may include the reference gaze difference parameter, an exemplary embodiment of the present disclosure may determine the gaze difference parameter for the first eye sample image and the second eye sample image by solving the difference between the first predicted gaze parameter and the second predicted gaze parameter. The above gaze difference parameter may essentially be a difference between a first predicted gaze parameter of a first eye sample image and a second predicted gaze parameter of a second eye sample image, of course, it may also be a relevant parameter used to represent the gaze difference. For example, by means of gaze angle, the first predicted gaze parameter can be defined as a first predicted gaze angle, and the second predicted gaze parameter can be defined as a second predicted gaze angle, in this case, the gaze difference parameter can be a difference between the first predicted gaze angle and the second predicted gaze angle.

Based on this, the method of the exemplary embodiment of the present disclosure can determine the first sub-loss parameter based on the reference gaze difference parameter and the gaze difference parameter, and use the first sub-loss parameter to determine a gaze direction prediction loss of the gaze prediction model to be constructed, so as to continuously reduce the gaze direction prediction loss of the gaze prediction model to be constructed during the training iteration process, thereby eliminating the prediction bias caused by individual differences and avoiding the model overfitting problem caused by the “data discreteness” of the training data set of eye sample images.

According to an embodiment of the present disclosure, the construction of the gaze prediction model may be performed based on the determined loss of the gaze prediction model to be constructed, for example, the gaze direction prediction loss of the gaze prediction model to be constructed. In some embodiments, the loss of the gaze prediction model to be constructed can be judged, for example, whether the loss meets a specific condition, and the processing related to the construction of the gaze prediction model can be performed based on the judgment result, as an example, the model construction can be continued or terminated based on the judgment result. The above judgement process may be performed in an appropriate manner, such as steps 104 to 106 described below.

Step 104: determining whether the loss of the gaze prediction model to be constructed meets a convergence condition. If the convergence condition is not met, it means that the currently trained gaze prediction model to be constructed has a relatively poor gaze prediction accuracy, and cannot be accurately used to predict the gaze information of the eye image, and then needs to be further trained to meet the gaze prediction accuracy, at this time, step 105 can be executed: if the convergence condition is met, it means that the gaze prediction accuracy of the currently trained gaze prediction model to be constructed is relatively high, and it can be accurately used to predict the gaze information of the eye image, at this time, step 106 can be executed.

In practical applications, the above-mentioned convergence condition may include various conditions. As an example, it may be the loss of the gaze prediction model to be constructed is less than or equal to a preset threshold. As another example, it may also refer to relevant information/conditions on the stability of the loss of the gaze prediction model to be constructed, such as the loss variation/fluctuation being less than a specific range, etc., the specific conditions can be determined according to the actual application scenario and are not limited here.

Step 105: updating the model parameters of the gaze prediction model to be constructed based on the gaze difference description information and the predicted gaze information.

The model parameters here may include weights and/or offset values. According to some embodiments of the present disclosure, the gaze prediction model to be constructed after parameter updating can be used for constructing the gaze prediction model again, for example, can be reapplied to the operations of the aforementioned steps 101-104, so as to perform the next round of gaze prediction model construction.

Step 106: determining the gaze prediction model to be constructed as the gaze prediction model.

At this point, the process of the gaze prediction model construction has been completed.

As an example, the construction of the gaze prediction model can be performed iteratively, in particular, at the beginning of the construction process, an initial gaze prediction model to be constructed and an initial auxiliary prediction model can be applied, and then the sample images are used as input to perform the aforementioned construction process, such as steps 101-104, if in step 104, it is determined that the loss of the gaze prediction model to be constructed does not meet the convergence condition, the parameters of the gaze prediction model to be constructed are updated, and then the gaze prediction model to be constructed with updated parameters is used to start the construction operation in the next iteration. On the other hand, if in step 104, it is determined that the loss of the gaze prediction model to be constructed meets the convergence condition, the iteration is terminated and the obtained gaze prediction model to be constructed can serve as the gaze prediction model. It should be noted that the above order of the steps 101 to 104 is only exemplary and there may be any other appropriate order. In an example, step 104 may be performed first, and then other steps may be performed. For example, it can be first determined whether the loss of the gaze prediction model to be constructed meets the convergence condition (it should be noted that in the operation for the first time, various model parameters, loss functions, etc. can all be default values or initial settings), if the convergence condition is not met, operations, such as steps 101-103 and 105, can be performed, if the convergence condition is met, the iteration is terminated and then the step 106 is executed. As an example, in the case of iterative operation, the convergence condition may also be related to the number of iterations, for example, if the number of iterations is greater than a certain number, it can be considered that the iteration condition is met.

It should be noted that the convergence condition may include at least one convergence condition, such as the convergence condition described herein, and the iteration may terminate as long as any convergence condition is met. The specific implementation can be determined according to the actual application scenario and are not limited here.

In the related technology, a disparity estimation model takes eye image pairs as input and outputs gaze difference information during the training process and the inference process. Therefore, in the actual inference process, it is necessary to first guide the user to look at a marker in a known direction (hereinafter referred to as the calibration direction) and collect a corresponding eye image as a subsequent calibration image. When an electronic device needs to estimate the user's gaze direction in real time, it is necessary to collect the user's eye image to be tested in real time, and estimate the gaze difference between the eye image to be tested and the aforementioned calibration image through a disparity estimation model, since the gaze direction of the calibration image is known, the gaze direction represented by the eye image to be tested can be determined based on the gaze difference estimated by the disparity estimation model and a calibration direction. However, when the calibration gaze is captured, the captured calibration image may not match the calibration direction due to some reasons, such as the user not looking at the marker in the calibration direction, or not looking at the marker at all. In this case, there is a large deviation in the gaze direction represented by the eye image to be tested determined based on the gaze difference estimated by the disparity estimation model and the calibration direction.

By the method according to the exemplary embodiment of the present disclosure, during the training stage of the gaze prediction model, the gaze difference description information output by the auxiliary prediction model is used as the supervision information of the eye sample image, which can not only reduce the cost of annotating samples, but also eliminate the gaze deviation caused by individual differences such as the angle between the eye's visual axis and the optical axis or the like, and avoid overfitting caused by “sample data discreteness” during the eye sample image acquisition process. On this basis, the gaze prediction model constructed by the method according to the exemplary embodiment of the present disclosure can directly output the corresponding gaze direction based on the input image to be tested, without needing to collect calibration images in the inference stage, thereby improving the user experience.

In practical applications, in the exemplary embodiment of the present disclosure, the gaze difference description information may further include a first eye image feature, and the predicted gaze information may further include a second eye image feature. At this time, the loss of the gaze prediction model to be constructed in the exemplary embodiment of the present disclosure may include not only the first loss parameter, but also the second loss parameter.

The first loss parameter can be determined based on the first predicted gaze parameter, the second predicted gaze parameter and the supervision information for the eye sample images, which is essentially a prediction loss. The specific content can refer to the above description and will not be repeated here. The second loss parameter can be determined based on the first eye image feature and the second eye image feature, and is essentially a feature loss.

An exemplary embodiment of the present disclosure may define eye sample images with annotated gaze directions as labeled eye sample images, and define eye sample images without annotated gaze directions as unlabeled eye sample images. From the viewpoint of the eye sample images having annotated gaze directions, the eye sample images of the exemplary embodiments of the present disclosure may include unlabeled eye sample images, labeled eye sample images, or both unlabeled eye sample images and labeled eye sample images. At this time, when the first loss parameter is determined, the supervision information for the eye sample image needs to be determined according to the actual scenarios.

It can be understood that, regardless of whether the eye sample images are unlabeled eye sample image or labeled eye sample images, the supervision information for the eye sample images can include a reference gaze difference parameter, the first loss parameter can include a first sub-loss parameter, and the first sub-loss parameter can be determined based on the reference gaze difference parameter and the gaze difference parameter. Here, the relevant content of the first sub-loss parameter can specifically refer to the above-mentioned description and will not be repeated here.

Therefore, when the eye sample images include unlabeled eye sample images, the exemplary embodiment of the present disclosure does not need to accurately annotate the unlabeled eye sample image, nor does it need to abandon usage of the unlabeled eye sample images, instead, the reference gaze difference parameter output by the auxiliary prediction model can be used as the supervision information for the eye sample images, and then the prediction loss of the gaze prediction model to be constructed can be determined (i.e., the first sub-loss parameter is determined). Therefore, in the training stage of the gaze prediction model, the unlabeled eye sample images that have not been accurately annotated can be fully learned, thereby reducing the cost of annotating samples and improving the utilization efficiency of the unlabeled eye sample images.

On this basis, when the eye sample images include labeled eye sample images, the supervision information for the eye sample images may further include the annotated gaze directions of all the eye sample images. For example, in the method according to the exemplary embodiments of the present disclosure, the annotated gaze directions of all eye sample images may include a first annotated gaze direction of the first eye sample image and a second annotated gaze direction of the second eye sample image. Here, the first annotated gaze direction may be used to annotate the eye gaze direction in the first eye sample image, and the second annotated gaze direction may be used to annotate the eye gaze direction in the second eye sample image. Based on this, the first loss parameter in the exemplary embodiment of the present disclosure may include a second sub-loss parameter. The second sub-loss parameter may be determined based on the first prediction loss parameter and the second prediction loss parameter, wherein the first prediction loss parameter may be determined based on the first annotated gaze direction and the first predicted gaze parameter, and the second predicted loss parameter may be determined based on the second annotated gaze direction and the second predicted gaze parameter.

For example, an exemplary embodiment of the present disclosure may determine a first prediction loss parameter based on a first annotated gaze direction and a first predicted gaze parameter, determine a second prediction loss parameter based on a second predicted gaze parameter and a second annotated gaze direction, and then determine a second sub-loss parameter based on a weighted result of the first predicted loss parameter and the second predicted loss parameter.

It can be seen that when the eye sample images include labeled eye sample images, the exemplary embodiment of the present disclosure can directly use the annotated gaze directions of the eye sample images as the supervisory information for the eye sample images, and use the annotated gaze directions of the accurately annotated eye sample image to determine the prediction loss of the gaze prediction model to be constructed (i.e., determine the second sub-loss parameter). At this time, the supervisory information for the labeled eye sample image can be fully utilized, thereby improving the utilization rate of the supervisory information for the labeled eye sample images.

On this basis, the loss of the gaze prediction model to be constructed in the exemplary embodiment of the present disclosure can be determined based on the weighted result of the first loss parameter and the second loss parameter. From the viewpoint of feature scale, both eye image features and predicted gaze information can be represented in the form of matrices, and their scales are quite different.

For example, for eye image features, the scale is relatively small, while the scale of predicted gaze information is large. Therefore, the second loss parameter is relatively small, while the first loss parameter is relatively large. At this time, the weight for the second loss parameter can be set greater than the weight for the first loss parameter, and the weight for the second loss parameter can be used to amplify the second loss parameter, so that the loss of the gaze prediction model to be constructed can fully consider the loss of eye image features, thereby improving the gaze prediction accuracy of the constructed gaze prediction model.

Therefore, the exemplary embodiment of the present disclosure can comprehensively determine the loss of the gaze prediction model to be constructed from two aspects: prediction loss and feature loss, so that the model parameters of the obtained gaze prediction model are optimal, the gaze parameters predicted by the gaze prediction model in the inference stage are more approximate to real gaze parameters of the eye image, thereby improving the gaze prediction accuracy of the gaze prediction model.

In practical applications, an exemplary embodiment of the present disclosure can add some branches to the gaze prediction model to be constructed, through which the image features extracted from the first eye sample image and the second eye sample image can be fused respectively, and the predicted gaze difference parameters of the first eye sample image and the second eye sample image can be output based on the fused features. Based on this, the predicted gaze information of the exemplary embodiment of the present disclosure may further include a predicted gaze difference parameter. Here, other than the gaze difference parameter of the first eye sample image and the second eye sample image determined based on the first predicted gaze parameter and the second predicted gaze parameter in the above-mentioned description, the predicted gaze difference parameter can be directly output through a branch added in the gaze prediction model to be constructed.

In this case, the loss of the gaze prediction model to be constructed may further include a third loss parameter, which is essentially a prediction loss, and the third loss parameter may be determined based on a reference gaze difference parameter and a predicted gaze difference parameter.

When the loss of the gaze prediction model to be constructed may include the first loss parameter, the second loss parameter and the third loss parameter, the loss of the gaze prediction model to be constructed may be determined based on a weighted result of the first loss parameter, the second loss parameter and the third loss parameter, and the weight for the first loss parameter and the weight for the third loss parameter are both smaller than the weight for the second loss parameter.

For example, a calculation formula for the loss of the gaze prediction model to be constructed is: Lₜₒₜₐₗ=X₁*L₁+X₂*L₂+X₃*L₃, wherein Lₜₒₜₐₗ represents the loss of the gaze prediction model to be constructed, L₁, L₂ and L₃ represent the first loss parameter, the second loss parameter and the third loss parameter respectively, and X₁, X₂ and X₃ represent the weight for the first loss parameter, the weight for the second loss parameter and the weight for the third loss parameter respectively.

Here, the third loss parameter, together with the first loss parameter, belongs to the prediction loss, and the scale of its corresponding annotated gaze direction of the eye sample image is also large, therefore, when the loss of the gaze prediction model to be constructed is determined, the weight for the first loss parameter and the weight for the third loss parameter are set to be smaller than the weight for the second loss parameter. At this time, the weight for the second loss parameter can be used to amplify the second loss parameter, so that the loss of the gaze prediction model to be constructed can fully consider the loss of eye image features, thereby improving the gaze prediction accuracy of the constructed gaze prediction model. For example, the values of X1 and X2 can be set to 1, and the value of X3 can be set to 100.

On this basis, the exemplary embodiment of the present disclosure can determine whether the loss of the gaze prediction model to be constructed meets the convergence condition during the training stage, if so, the currently trained gaze prediction model to be constructed is determined to be the gaze prediction model; otherwise, the model parameters of the gaze prediction model to be constructed can be updated based on the gaze difference description information and the predicted gaze information.

In practical applications, in each iterative training process, when the supervision information for the eye sample images includes a reference gaze difference parameter, a first annotated gaze direction, and a second annotated gaze direction, the loss of the gaze prediction model to be constructed can be determined based on a weighted result of the first sub-loss parameter, the second loss parameter, and the third loss parameter, and then it is determined whether the loss of the gaze prediction model to be constructed meets a convergence condition for the gaze prediction model to be constructed. If the loss of the gaze prediction model to be constructed does not meet the convergence condition for the gaze prediction model to be constructed, the model parameters of the gaze prediction model to be constructed can be updated based on the reference gaze difference parameters and the gaze difference parameters, the first eye image features and the second eye image features, and the reference gaze difference parameters and the predicted gaze difference parameters. Here, the convergence condition for the gaze prediction model to be constructed may include that the loss of the gaze prediction model to be constructed is less than or equal to a first preset threshold, or it may refer to that the loss of the gaze prediction model to be constructed is stable, such condition can be determined according to the actual application scenario and is not limited here.

When the supervision information for the eye sample image includes a reference gaze difference parameter, the loss of the gaze prediction model to be constructed can be determined based on the weighted result of the second sub-loss parameter, the second loss parameter and the third loss parameter, and then it is judged whether the loss of the gaze prediction model to be constructed meets the convergence condition for the gaze prediction model to be constructed. If the loss of the gaze prediction model to be constructed does not meet the convergence condition for the gaze prediction model to be constructed, the model parameters of the gaze prediction model to be constructed can be updated based on the first annotated gaze direction and the first predicted gaze parameter, the second annotated gaze direction and the second predicted gaze parameter, the first eye image feature and the second eye image feature, and the reference gaze difference parameter and the predicted gaze difference parameter. Here, the convergence condition for the gaze prediction model to be constructed may include that the loss of the gaze prediction model to be constructed is less than or equal to a second preset threshold, or it may refer to that the loss of the gaze prediction model to be constructed is stable, such condition can be determined according to the actual application scenario and is not limited here.

In an optional manner, when the supervision information for the eye sample image includes a reference gaze difference parameter, a first annotated gaze direction, and a second annotated gaze direction, the auxiliary prediction model may be an untrained or pre-trained network model. At this time, the auxiliary prediction model can be trained while the gaze prediction model to be constructed is being trained. Based on this, the method of the exemplary embodiment of the present disclosure may further include: updating the model parameters of the auxiliary prediction model based on the reference gaze difference parameter and the annotated gaze difference parameter, and the annotated gaze difference parameter may be determined based on the first annotated gaze direction and the second annotated gaze direction. The model parameters here may include weights and/or offset values.

Since the first annotated gaze direction and the second annotated gaze direction are the “ground-truth labels” for the first eye sample image and the second eye sample image respectively, the annotated gaze difference parameter determined based on the first annotated gaze direction and the second annotated gaze direction is also the “ground-truth label” of the eye sample image. At this time, the loss of the currently trained auxiliary prediction model can be determined based on the annotated gaze difference parameters and the reference gaze difference parameters output by the auxiliary prediction model, if the loss of the currently trained auxiliary prediction model does not meet the convergence condition for the auxiliary prediction model, it means that the convergence degree of the currently trained auxiliary prediction model is not high, then the model parameters of the auxiliary prediction model can be updated based on the reference gaze difference parameters and the annotated gaze difference parameters; otherwise, there is no need to update the model parameters of the auxiliary prediction model.

Taking into account that the eye sample images used in each iterative training process may or may not have annotated gaze directions, the method of the exemplary embodiment of the present disclosure can update the model parameters of the gaze prediction model to be constructed separately, or can update the model parameters of the gaze prediction model to be constructed and the model parameters of the auxiliary prediction model concurrently. It is understandable that the updating of the model parameters of the gaze prediction model to be constructed occurs in each iterative training, while the updating of the model parameters of the auxiliary prediction model may occur in the iterative training in which the first eye sample image has a first annotated gaze direction and the second eye sample image has a second annotated gaze direction. That is to say, when the first eye sample image has a first annotated gaze direction and the second eye sample image has a second annotated gaze direction, and the loss of the currently trained auxiliary prediction model does not meet the convergence condition for the auxiliary prediction model, the model parameters of the auxiliary prediction model will be updated based on the reference gaze difference parameters and the annotated gaze difference parameters.

Exemplarily, during each iterative training process, if the first eye sample image has a first annotated gaze direction and the second eye sample image has a second annotated gaze direction, an exemplary embodiment of the present disclosure can determine the loss of the auxiliary prediction model based on reference gaze difference parameters and annotated gaze difference parameters determined based on the first annotated gaze direction and the second annotated gaze direction, and then determine whether the loss of the currently trained auxiliary prediction model meets a convergence condition for the auxiliary prediction model. If the loss of the currently trained auxiliary prediction model does not meet the convergence condition for the auxiliary prediction model, it means that the convergence degree of the currently trained auxiliary prediction model is not high, and there exist certain differences between the reference gaze difference parameters output by the currently trained auxiliary prediction model and the annotated gaze difference parameters, at this time, the model parameters of the auxiliary prediction model can be updated based on the reference gaze difference parameters and the annotated gaze difference parameters, so that the reference gaze difference parameters output by the auxiliary prediction model are more approximate to the labeled gaze difference parameters in the next iterative training process, and the gaze difference prediction accuracy of the auxiliary prediction model is higher, thereby making the predicted gaze difference parameters output by the branches added in the gaze prediction model to be constructed in the next iterative training process more accurate. Here, the convergence condition for the auxiliary prediction model may include that the loss of the auxiliary prediction model is less than or equal to a second preset threshold, or may refer to that the loss of the auxiliary prediction model is stable, which can be determined according to the actual application scenarios and is not limited here.

Based on this, if the loss of the auxiliary prediction model does not meet the convergence condition for the auxiliary prediction model, the method of an exemplary embodiment of the present disclosure may further include: determining the annotated gaze difference parameters based on the first labeled gaze direction and the second labeled gaze direction; and calibrating the reference gaze difference parameters based on the annotated gaze difference parameters. Here, the determination of the annotated gaze difference parameters can refer to the above-mentioned application and will not be repeated here.

If the loss of the currently trained auxiliary prediction model does not meet the convergence condition for the auxiliary prediction model, it means that the convergence degree of the currently trained auxiliary prediction model is not high, and there exist certain differences between the reference gaze difference parameters output by the currently trained auxiliary prediction model and the annotated gaze difference parameters, an exemplary embodiment of the present disclosure can calibrate the reference gaze difference parameters based on the labeled gaze difference parameters while updating the model parameters of the auxiliary prediction model based on the reference gaze difference parameters and the labeled gaze difference parameters, so as to make the calibrated reference gaze difference parameters more approximate to the annotated gaze difference parameters. Therefore, the third loss parameters determined based on the calibrated reference gaze difference parameters and the predicted gaze difference parameters output by the branches added in the gaze prediction model to be constructed are smaller, at this time, the prediction accuracy of the predicted gaze difference parameters output by the branches added in the gaze prediction model to be constructed is higher. Meanwhile, the method of an exemplary embodiment of the present disclosure can further update the model parameters of the gaze prediction model to be constructed based on the calibrated reference gaze difference parameters and the predicted gaze difference parameters output by the branches added in the gaze prediction model to be constructed during the current iteration process, and can further improve the gaze prediction accuracy of the gaze prediction model to be constructed in the next iteration process.

It can be seen that in the method of the exemplary embodiments of the present disclosure, since the updating of the model parameters of the gaze prediction model to be constructed occurs in each training iteration process, in the iterative training process of updating the model parameters of the auxiliary prediction model, when the model parameters of the gaze prediction model to be constructed are updated, the updating of the model parameters of the gaze prediction model to be constructed will be iteratively performed based on the reference gaze difference parameters output by the auxiliary gaze model and the predicted gaze difference parameters output by the branches added in the gaze prediction model to be constructed. Therefore, the gaze prediction model to be constructed can learn the reference gaze difference parameters output by the auxiliary prediction model, and after multiple iterative training, the gaze difference prediction accuracy of the auxiliary prediction model will be gradually improved, and the improvement process of the gaze difference prediction accuracy of the auxiliary gaze model will also be learned by the gaze prediction model to be constructed, so that the gaze prediction model to be constructed can learn the generalization ability of the auxiliary gaze model.

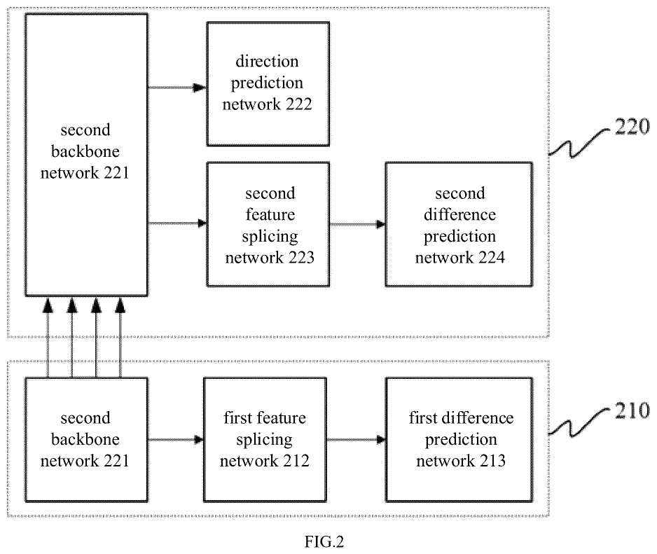

In an optional manner, FIG. 2 shows a schematic diagram of a model architecture of an exemplary embodiment of the present disclosure. As shown in FIG. 2, the model architecture of the exemplary embodiment of the present disclosure may include an auxiliary gaze model 210 and a gaze prediction model 220, the auxiliary prediction model 210 may include a first backbone network 211, a first feature splicing network 212 and a first difference prediction network 213. The gaze prediction model 220 to be constructed may include a second backbone network 221 and a direction prediction network 222.

The first backbone network 211 contains a first basic module, which can be configured to output a first eye image feature; the first feature splicing network 212 can be configured to determine a first gaze splicing feature based on the first eye image feature; the first difference prediction network 213 can be configured to determine reference gaze difference parameters based on the first gaze splicing feature.

Exemplarily, the first backbone network 211 can acquire the first eye image feature based on a first eye sample image and a second eye sample image, and then the first feature splicing network 212 can acquire a first gaze feature of the first eye sample image and a second gaze feature of the second eye sample image based on the first eye image feature, and splice the first gaze feature of the first eye sample image and the second gaze feature of the second eye sample image into a first gaze splicing feature. The first difference prediction network 213 fuses the first gaze splicing features to obtain the reference gaze difference parameters. Based on this, since the first gaze feature of the first eye sample image and the second gaze feature of the second eye sample image have been spliced, individual differences such as the angle between the visual axis and the optical axis, etc. have been eliminated. Therefore, when the reference gaze difference parameters are used as the supervision information for the eye sample images, the gaze deviation caused by individual differences can be eliminated, avoiding the overfitting problem caused by “data discreteness”.

The second backbone network 221 includes a second basic module, which can be configured to output a second eye image feature; the direction prediction network 222 can be configured to determine a first predicted gaze parameter and a second predicted gaze parameter based on the second eye image feature.

Exemplarily, the second backbone network 221 can acquire the second eye image feature based on the first eye sample image and the second eye sample image, the direction prediction network 222 can acquire a third gaze feature of the first eye sample image based on the first eye sample image, and acquire a fourth gaze feature of the second eye sample image based on the second eye sample image, at this time, the direction prediction network 222 can further acquire the first predicted gaze parameter of the first eye sample image based on the third gaze feature of the first eye sample image, and acquire the second predicted gaze parameter of the second eye sample image based on the fourth gaze feature of the second eye sample image.

Taking into account that the number of channels of the first eye image feature output by the first basic module in each layer and the number of channels of the second eye image features output by the second basic module in the corresponding layer may be different, at this time, it is necessary to adjust the number of channels of the first eye image features output by the first basic module to be the same as the number of channels of the second eye image features output by the second basic module in the same layer. Therefore, the eye feature difference parameters in each layer can be determined by the first eye image feature and the second eye image feature with the same number of channels.

For example, the feature map size of the first eye image feature is H₁*W₁*C₁, and the feature map size of the second eye image feature is H₂*W₂*C₂, after the number of channels is adjusted, the feature map size of the first eye image feature is H₁*W₁, and the feature map size of the second eye image feature is H₂*W₂, then, the second loss parameter can be determined based on the first eye image feature and the second eye image feature.

When the first backbone network contains multiple layers of first basic modules and the second backbone network contains multiple layers of second basic modules, the first basic modules and the second basic modules have the same number of layers, and the first basic modules corresponds to the second basic modules in each layer.

For example, when the number of layers of the first basic module and the number of layers of the second basic module are both 4, the first backbone network 211 may include four layers of first basic modules connected in series, a first basic module in each layer can be used to extract a first eye image feature, a Layer 1 first basic module can extract a Layer 1 first eye image feature, the Layer 1 first eye image feature is used as input to a Layer 2 first basic module, the Layer 2 first basic module can extract a Layer 2 first eye image feature based on the Layer 1 first eye image feature, and so on, until a Layer 4 first basic module extract a Layer 4 first eye image feature, and the Layer 4 first eye image feature can be determined as the first eye image feature. The second backbone network 221 may include four layers of second basic modules connected in series, a second basic module in each layer can be used to extract a second eye image feature, a Layer 1 second basic modules can extract a Layer 1 second eye image feature, the Layer 1 second eye image feature can be used as input to a Layer 2 second basic module, the Layer 2 second basic module can extract a Layer 2 second eye image feature based on the Layer 1 second eye image feature, and so on, until a Layer 4 second basic module can extract a Layer 4 second eye image feature, and the Layer 4 second eye image feature can be determined as the second eye image feature.

Based on this, the second loss parameters of the exemplary embodiment of the present disclosure can be determined by multiple layers of eye feature difference parameters, and the eye feature difference parameters in each layer can be determined based on the first eye image features output by the first basic module of the corresponding layer and the second eye image features output by the second basic module of the corresponding layer.

Exemplarily, the exemplary embodiment of the present disclosure can first determine eye feature difference parameters in each layer based on the first eye image feature output by the first basic module of the corresponding layer and the second eye image feature output by the second basic module of the corresponding layer; and then determine a second loss function based on multiple layers of eye feature difference parameters. For example, the exemplary embodiment of the present disclosure can determine the second loss function based on the weighted results of the multiple layers of eye feature difference parameters, a weight for the eye feature difference parameters in each layer can be the same or different, which can be determined depending on actual scenarios and are not specifically limited here.

It can be seen that the method of the exemplary embodiment of the present disclosure can determine the second loss parameters of the second eye image feature relative to the first eye image feature layer by layer, so that the gaze prediction model can deeply learn the ability of the auxiliary prediction model to extract eye image features during the training stage, thereby improving the prediction accuracy of the gaze prediction model in the inference stage.

In an optional manner, when the predicted gaze information can further include predicted gaze difference parameters, the gaze prediction model 220 to be constructed can further include a second feature splicing network 223 and a second difference prediction network 224, the second feature splicing network 223 can be used to determine a second gaze splicing feature based on the second eye image feature, and the second difference prediction network 224 can be used to determine the predicted gaze difference parameters based on the second gaze splicing feature. Here, the second feature splicing network 223 and the second difference prediction network 224 can be understood as branches added to the gaze prediction model 220 to be constructed as mentioned above.

Exemplarily, the second backbone network 221 can acquire the second eye image feature based on the first eye sample image, and then the second feature splicing network 223 can acquire a fifth gaze feature of the first eye sample image and a sixth gaze feature of the second eye sample image based on the second eye image feature, and splice the fifth gaze feature of the first eye sample image and the sixth gaze feature of the second eye sample image into a second gaze splicing feature. The second difference prediction network 224 fuses the second gaze splicing features to acquire the predicted gaze difference parameters.

It should be noted that, in the training stage of the gaze prediction model, the gaze prediction model 220 to be constructed may include a second backbone network 221 and a direction prediction network 222, as well as a second feature splicing network 223 and a second difference prediction network 224. In each iteration process, the second feature splicing network 223 and the second difference prediction network 224 may be used as branches added in the gaze prediction model 220 to be constructed as mentioned above, when the predicted gaze difference parameters are output in the training stage, the second feature splicing network 223 and the second difference prediction network 224 may learn the process in which the first feature splicing network 212 and the first difference prediction network 213 in the auxiliary prediction model 210 output reference gaze difference parameters, and thus the processing of improving the gaze difference prediction accuracy of the auxiliary gaze model through multiple iterative trainings can further be learned by the gaze prediction model to be constructed, thereby enabling the gaze prediction model to be constructed to learn the generalization ability of the auxiliary gaze model. When the gaze prediction model training is completed, the model architecture of the gaze prediction model in the inference stage may include the second backbone network 221 and the direction prediction network 222, and at this time, may be smaller and simpler, and more conducive to deployment on edge devices such as wearable devices, compared with the model architecture of the gaze prediction model 220 to be constructed in the training stage.

The exemplary embodiments of the present disclosure further provide a gaze prediction method, which can improve the gaze prediction accuracy in the inference stage based on the gaze prediction model trained by the exemplary embodiments of the present disclosure. It should be understood that the method of the exemplary embodiments of the present disclosure may be executed by an electronic device, or may be executed by a chip applied to the electronic device. Please refer to the previous article for the specific content, which will not be repeated here.

FIG. 3 shows a flow chart of a gaze prediction method according to an exemplary embodiment of the present disclosure. As shown in FIG. 3, the gaze prediction method of an exemplary embodiment of the present disclosure may include:
Step 301: acquire a target eye image. The details of the target eye image can refer to the above-mentioned eye image, which will not be repeated here.
Step 302: input the target eye image into a gaze prediction model to obtain gaze parameters corresponding to the target eye image, wherein the gaze prediction model can be trained by the method of the exemplary embodiment of the present disclosure.

If the target eye image is an unlabeled eye sample image, the gaze prediction model can be used to predict the gaze parameters corresponding to the target eye image. If the target eye image is a labeled eye sample image, the gaze parameters corresponding to the target eye image predicted by the gaze prediction model may be used to calibrate the supervision information for the labeled eye sample image.

It can be seen that the method of the exemplary embodiment of the present disclosure can use the gaze prediction model trained by the exemplary embodiment of the present disclosure to predict the gaze parameters corresponding to the target eye image, the gaze prediction model can utilize the gaze difference description information output by the auxiliary prediction model as the supervision information for the eye sample images during the training stage, which can achieve advantageous effects, for example, including but not limited to at least one of the following: on one hand reducing the cost of annotating samples, on the other hand eliminating the gaze deviation caused by individual differences such as the angle between the eye's visual axis and the optical axis or the like, on yet another hand avoiding overfitting caused by “sample data discreteness” during the eye sample image acquisition process. Additionally or alternatively, the obtained gaze prediction model can be directly used to predict the gaze direction corresponding to the eye image to be tested during the inference stage, without needing to first acquire a calibration image for calibration. Additionally or alternatively, after the gaze prediction model training is completed, the model architecture of the gaze prediction model in the inference stage is smaller and simpler than the model architecture of the gaze prediction model to be constructed in the training stage, and is more conducive to deployment on edge devices such as wearable devices.

One or more technical solutions provided in the exemplary embodiments of the present disclosure can input the first eye sample image and the second eye sample image into an auxiliary prediction model to obtain gaze difference description information, and input the first eye sample image and the second eye sample image into a gaze prediction model to be constructed to obtain predicted gaze information, and the predicted gaze information can include a first predicted gaze parameter of the first eye sample image and a second predicted gaze parameter of the second eye sample image. Since the gaze difference description information can be used to represent the gaze difference between the first eye sample image and the second eye sample image, when the exemplary embodiment of the present disclosure can utilize the gaze difference description information output by the auxiliary prediction model as the supervision information for the eye sample images during the training stage, advantageous effects can be achieved, for example, including but not limited to at least one of the following: on one hand reducing the cost of annotating samples, on the other hand eliminating the gaze deviation caused by individual differences such as the angle between the eye's visual axis and the optical axis or the like, on yet another hand avoiding overfitting caused by “sample data discreteness” during the eye sample image acquisition process. Additionally or alternatively, the obtained gaze prediction model can be directly used to predict the gaze direction corresponding to the eye image to be tested during the inference stage, without needing to first acquire a calibration image for calibration.

Hereinafter, an apparatus according to an embodiment of the present disclosure will be described. The apparatus provided by the embodiments of the present disclosure can execute various methods provided by any embodiment of the present disclosure, the embodiments of the present disclosure can divide the functional units of the apparatus according to the above method examples, for example, each functional module/unit can be divided corresponding to each function, or two or more functions can be integrated into one processing module. It is worth noting that the various modules/units included in the above-mentioned apparatus are only divided according to functional logics, but are not limited to the division described in the text, in actual implementation, there may be other division manners as long as the corresponding functions can be achieved; in addition, the specific names of various modules/units are only for the convenience of distinguishing each other and are not used to limit the protection scope of the embodiments of the present disclosure. In addition, each module/unit may be implemented in various appropriate ways, such as hardware, firmware, or any appropriate combination.

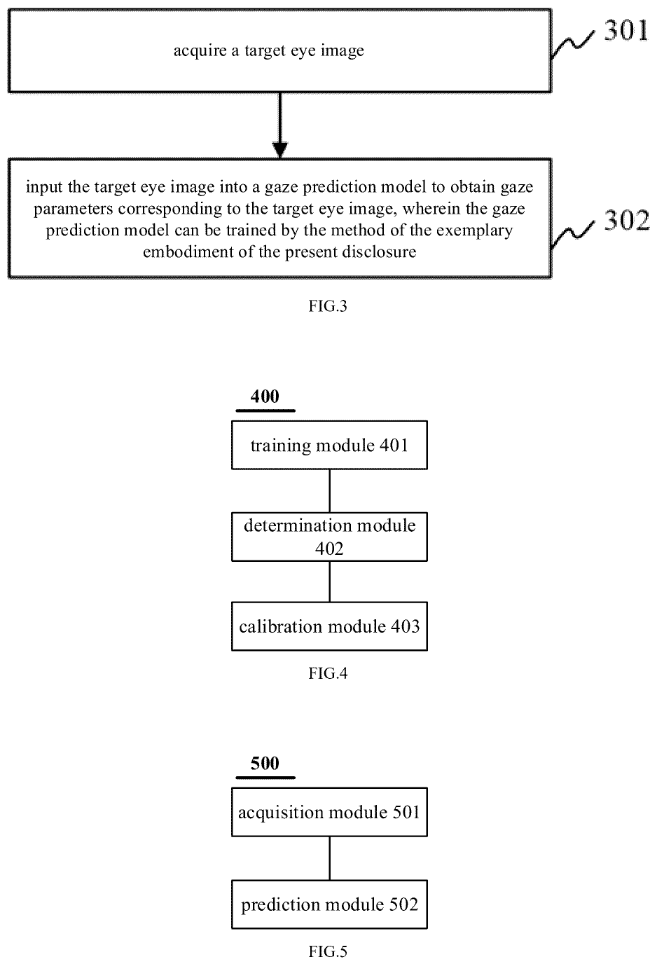

In the case of dividing each functional module corresponding to each function, an exemplary embodiment of the present disclosure provides an apparatus for constructing a gaze prediction model, and the apparatus for constructing a gaze prediction model may be an electronic device or a chip applied to an electronic device. FIG. 4 shows a schematic block diagram of modules of an apparatus for constructing a gaze prediction model according to an exemplary embodiment of the present disclosure. As shown in FIG. 4, the apparatus 400 includes:
a training module 401, configured to input a first eye sample image and a second eye sample image into an auxiliary prediction model to obtain gaze difference description information, wherein the gaze difference description information is used to represent a gaze difference between the first eye sample image and the second eye sample image; input the first eye sample image and the second eye sample image into the gaze prediction model to be constructed to obtain predicted gaze information, where the predicted gaze information includes a first predicted gaze parameter of the first eye sample image and a second predicted gaze parameter of the second eye sample image; determine a loss of the gaze prediction model to be constructed based on the gaze difference description information and the predicted gaze information; in response to that the loss of the gaze prediction model to be constructed does not meet a convergence condition, update model parameters of the gaze prediction model to be constructed based on the gaze difference description information and the predicted gaze information; and
a determination module 402, configured to, in response to that the loss of the gaze prediction model to be constructed meets the convergence condition, determine the gaze prediction model to be constructed as the gaze prediction model.

As an optional implementation, the gaze difference description information includes a first eye image feature and a reference gaze difference parameter, the predicted gaze information further includes a second eye image feature, and the loss of the gaze prediction model to be constructed includes a first loss parameter and a second loss parameter;

Among them, the first loss parameter is determined based on the first predicted gaze parameter, the second predicted gaze parameter and supervision information for the eye sample images, the supervision information for the eye sample images includes the reference gaze difference parameter, and the second loss parameter is determined based on the first eye image feature and the second eye image feature.

As an optional implementation, the loss of the gaze prediction model to be constructed is determined based on a weighted result for the first loss parameter and the second loss parameter, and a weight for the second loss parameter is greater than a weight for the first loss parameter.

As an optional implementation, the first loss parameter includes a first sub-loss parameter and a second sub-loss parameter;

The first sub-loss parameter is determined based on the reference gaze difference parameter and a gaze difference parameter, and the gaze difference parameter is determined based on a difference between a first predicted sight parameter and a second predicted sight parameter;

The supervision information for the eye sample images further includes a first annotated gaze direction of the first eye sample image and a second annotated gaze direction of the second eye sample image, the second sub-loss parameter is determined based on the first predicted loss parameter and the second predicted loss parameter, the first predicted loss parameter is determined based on the first annotated gaze direction and the first predicted gaze parameter, the second predicted loss parameter is determined based on the second annotated gaze direction and the second predicted gaze parameter.

As an optional implementation, the predicted gaze information further includes a predicted gaze difference parameter, and the loss of the gaze prediction model to be constructed further includes a third loss parameter, and the third loss parameter is determined based on the predicted gaze difference parameter and the reference gaze difference parameter, the training module 401 is further configured to update the model parameters of the auxiliary prediction model based on the reference gaze difference parameter and an annotated gaze difference parameter, and the annotated gaze difference parameter is determined based on the first annotated gaze direction and the second annotated gaze direction.

As an optional implementation, the loss of the gaze prediction model to be constructed is determined based on a weighted result of the first loss parameter, the second loss parameter and the third loss parameter, and the weight for the first loss parameter and the weight for the third loss parameter are both smaller than the weight for the second loss parameter.

As an optional implementation, the determination module 402 is further configured to determine the annotated gaze difference parameter based on the first annotated gaze direction and the second annotated gaze direction; it should be noted that, alternatively, the determination of the annotated gaze difference parameter may be implemented by the training module 401.

The apparatus 400 further includes a calibration module 403 configured to calibrate the reference gaze difference parameter based on the annotated gaze difference parameter. It should be noted that the calibration module can be implemented separately from other modules, or included in other modules, for example, can be included in the training module, or its function can be implemented by the training module.

As an optional implementation, the auxiliary prediction model includes a first backbone network, a first feature splicing network, and a first difference prediction network, and the gaze prediction model to be constructed includes a second backbone network and a direction prediction network;

The first backbone network includes a first basic module configured to output a first eye image feature, the first feature splicing network is configured to determine a first gaze splicing feature based on the first eye image feature, and the first difference prediction network is configured to determine the reference gaze difference parameter based on the first gaze splicing feature;

The second backbone network contains a second basic module configured to output a second eye image feature, and the direction prediction network is configured to determine the first predicted gaze parameter and the second predicted gaze parameter based on the second eye image feature.

As an optional implementation, the first backbone network contains multiple layers of first basic modules, and the second backbone network contains multiple layers of second basic modules, the first basic module corresponds to the second basic module in each layer, the second loss parameter is determined by the multiple layers of eye feature difference parameters, and the eye feature difference parameter in each layer is determined based on the first eye image feature output by the first basic module in the corresponding layer and the second eye image feature output by the second basic module in the corresponding layer.

As an optional implementation, when the predicted gaze information further includes the predicted gaze difference parameter, the gaze prediction model to be constructed further includes a second feature splicing network and a second difference prediction network, the second feature splicing network is configured to determine the second gaze splicing feature based on the second eye image feature, and the second difference prediction network is configured to determine the predicted gaze difference parameter based on the second gaze splicing feature.

An exemplary embodiment of the present disclosure further provides a gaze prediction apparatus, which may be an electronic device or a chip applied to the electronic device. FIG. 5 shows a schematic block diagram of modules of a gaze prediction apparatus according to an exemplary embodiment of the present disclosure.

As shown in FIG. 5, the apparatus 500 includes:
an acquisition module 501, configured to acquire a target eye image;
a prediction module 502, configured to input the target eye image into a gaze prediction model to obtain a gaze parameter corresponding to the target eye image, wherein the gaze prediction model is trained by the apparatus described in exemplary embodiments of the present disclosure.

The solutions proposed by the embodiments of the present disclosure have been described above. It can be understood that, in order to realize the above functions, an electronic device includes corresponding hardware structures and/or software modules for executing various functions. Those skilled in the art should readily appreciate that, in combination with the units and algorithm steps of the various examples described in the embodiments disclosed herein, the present disclosure can be implemented in the form of hardware or a combination of hardware and computer software. Whether a function is performed by hardware or by computer software driving hardware depends on the specific application and design constraints of the technical solution. A skilled person may use different methods to implement the described functions for each specific application, but such implementation should not be considered to be beyond the scope of the present disclosure.

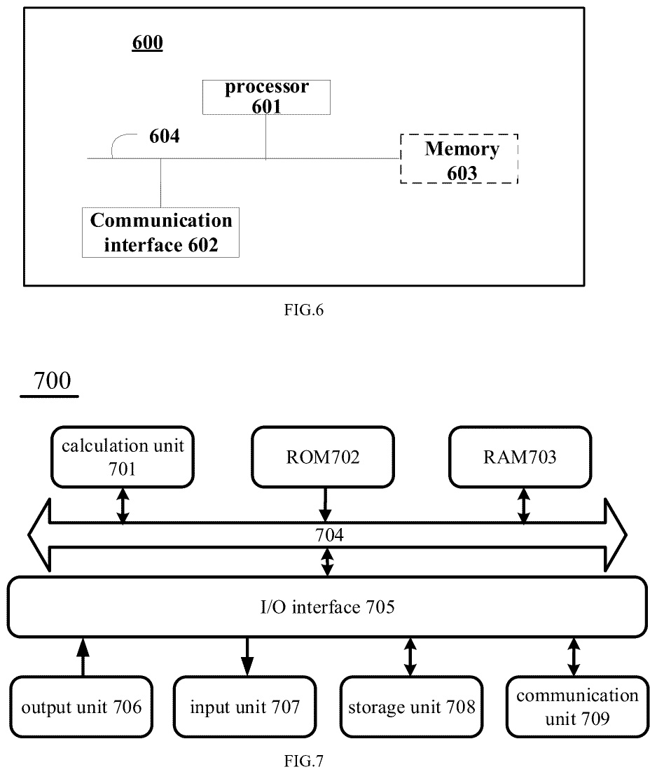

FIG. 6 shows a schematic block diagram of a chip according to an exemplary embodiment of the present disclosure. As shown in FIG. 6, the chip 600 includes one or more than two (including two) processors 601 and a communication interface 602. The communication interface 602 can support the server to perform the data transceiving steps in the above method, and the processor 601 can support the server to perform the data processing steps in the above method.

Optionally, as shown in FIG. 6, the chip 600 further includes a memory 603, which may include a read-only memory and a random access memory, and provides operating instructions and data to the processor. A part of the memory may further include a non-volatile random access memory (NVRAM).

In some embodiments, as shown in FIG. 6, the processor 601 executes corresponding operations by calling operation instructions stored in the memory (which can be stored in the operating system). The processor 601 controls the processing operation of any one of the terminal devices, and the processor can also be called a central processing unit (CPU). The memory 603 may include a read only memory and a random access memory, and provides instructions and data to the processor 601. A part of the memory 603 may also include NVRAM. For example, memory, communication interface and memory are coupled together through a bus system, wherein the bus system can include a power bus, a control bus and a status signal bus, etc., in addition to a data bus. But for the sake of clarity, various buses are labeled as bus system 604 in FIG. 6.

The method disclosed in the embodiments of the present disclosure can be applied to or realized by a processor. The processor may be an integrated circuit chip with signal processing capability. In a process of implementation, the steps of the above method can be completed by hardware integrated logic circuits or software instructions in the processor. The processor can be a general processor, a digital signal processing (DSP), an ASIC, a field-programmable gate array (FPGA) or other programmable logic devices, discrete gate or transistor logic devices, and discrete hardware components. The methods, steps and logic block diagrams disclosed in that embodiments of the present disclosure may be implemented or executed. The general processor can be a microprocessor or the processor can be any conventional processor, etc. The steps of the method disclosed in combination with the embodiments of the present disclosure can be directly embodied as the completion of execution by a hardware decoding processor, or the completion of execution by a combination of software modules and hardware in the decoding processor. Software modules can be located in a random access memory, a flash memory, a read-only memory, a programmable read-only memory or an electrically erasable programmable memory, registers and other mature storage media in this field. The storage medium is located in the memory, and the processor reads the information in the memory and combines its hardware to complete the steps of the above method.

An embodiment of the present disclosure further provides an electronic device, comprising: at least one processor; and a memory communicately connected with the at least one processor. The memory stores computer programs and/or instructions executable by the at least one processor, wherein the computer programs and/or instructions, when executed by the at least one processor, cause the electronic device to implement the method according to the embodiments of the present disclosure.

An embodiment of the present disclosure further provides a non-transitory computer-readable storage medium having thereon stored computer programs and/or instructions, which, when executed by a computer, cause the computer to implement the method according to the embodiments of the present disclosure.

An embodiment of the present disclosure further provides a computer program product containing instructions and/or computer programs, which, when executed by a processor of a computer, cause the computer to implement the method according to the embodiments of the present disclosure.

An embodiment of the present disclosure further provides a computer program containing program codes, which, when executed by a processor, cause the processor to implement the method according to the embodiments of the present disclosure.

Referring to FIG. 7, a structural block diagram of an electronic device 700 of the present disclosure that can be a server or a client will now be described, which is an example of a hardware device that can be applied to various aspects of the present disclosure. The electronic device is intended to represent various forms of digital electronic computer devices, such as laptop computers, desktop computers, workstations, personal digital assistants, servers, blade servers, mainframe computers, and other suitable computers. The electronic device can also represent various forms of mobile devices, such as personal digital processors, cellular phones, smart phones, wearable devices and other similar computing devices. The components shown herein, their connections and relationships, and their functions are only examples, instead of being intended to limit the implementation of the present disclosure described and/or claimed herein.

As shown in FIG. 7, an electronic device 700 includes a computing unit 701, which can perform various appropriate actions and processes according to a computer program stored in a read-only memory (ROM) 702 or a computer program loaded from a storage unit 708 into a random access memory (RAM) 703. In RAM 703, various programs and data required for the operation of the device 700 can also be stored. A computing unit 701, a ROM 702 and a RAM 703 are connected to each other through a bus 704. An input/output (I/O) interface 705 is also connected to the bus 704.

A plurality of components in the electronic device 700 are connected to the I/O interface 705, including an input unit 706, an output unit 707, a storage unit 708 and a communication unit 709. The input unit 707 can be any type of device that can input information to the electronic device 700, and the input unit 706 can receive input numeric or character information and generate key signal input related to user settings and/or function control of the electronic device. The output unit 707 may be any type of device capable of presenting information, and may include but not limited to a display, a speaker, a video/audio output terminal, a vibrator and/or a printer. The storage unit 708 may include, but is not limited to, a magnetic disk and an optical disk. The communication unit 709 allows the electronic device 700 to exchange information/data with other devices through a computer network such as the Internet and/or various telecommunication networks, and may include but not limited to a modem, a network card, an infrared communication device, a wireless communication transceiver and/or a chipset, such as a Bluetooth TM device, a WiFi device, a WiMax device, a cellular communication device and/or the like.

As shown in FIG. 7, the computing unit 701 can be various general and/or specific processing components with processing and computing capabilities. Some examples of the computing unit 701 include, but are not limited to, a central processing unit (CPU), a graphics processing unit (GPU), various specific artificial intelligence (AI) computing chips, various computing units running machine learning model algorithms, a digital signal processor (DSP), and any suitable processor, controller, microcontroller, etc. The computing unit 701 performs the various methods and processes described above. For example, in some embodiments, the method of the exemplary embodiment of the present disclosure may be implemented as a computer software program tangibly embodied in a machine-readable medium, such as the storage unit 708. In some embodiments, part or all of the computer program may be loaded and/or installed on the electronic device 700 via the ROM 702 and/or the communication unit 709. In some embodiments, the computing unit 701 may be configured to perform the method by any other suitable means (for example, by means of firmware).

The program codes for implementing the method of the present disclosure can be written in any combination of one or more programming languages. These program codes may be provided to a processor or controller of a general-purpose computer, a special-purpose computer or other programmable data processing apparatus, so that the program codes, when executed by a processor or controller, cause the functions/operations specified in the flowcharts and/or block diagrams to be implemented. The program codes can be completely executed on a machine, partially executed on a machine, partially executed on a machine as a separate software package and partially executed on a remote machine, or completely executed on a remote machine or server.

In the context of the present disclosure, a machine-readable medium may be a tangible medium that may contain or store a program for use by or in connection with an instruction execution system, apparatus or device. The machine-readable medium may be a machine-readable signal medium or a machine-readable storage medium. A machine-readable medium may include, but is not limited to, an electronic, magnetic, optical, electromagnetic, infrared, or semiconductor system, device or equipment, or any suitable combination of the above. More specific examples of the machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

As used in the present disclosure, the terms “machine-readable medium” and “computer-readable medium” refer to any computer program product, apparatus, and/or device (e.g., magnetic disk, optical disk, memory, programmable logic device (PLD)) for providing machine instructions and/or data to a programmable processor, including machine-readable media that receive machine instructions as machine-readable signals. The term “machine-readable signal” refers to any signal used to provide machine instructions and/or data to a programmable processor.

In order to provide interaction with users, the systems and techniques described herein can be implemented on a computer having a display device (for example, a CRT (cathode ray tube) or an LCD (liquid crystal display) monitor) for displaying information to users; and a keyboard and a pointing device (for example, a mouse or a trackball) through which a user can provide input to the computer. Other kinds of devices can also be used to provide interaction with users; for example, the feedback provided to the user can be any form of sensory feedback (for example, visual feedback, auditory feedback, or tactile feedback); and the input from the user can be received in any form, including acoustic input, voice input or tactile input.

The systems and techniques described herein may be implemented in a computing system that includes a back-end component (e.g., as a data server), a computing system that includes a middleware component (e.g., an application server), or a computing system that includes a front-end component (e.g., a user computer with a graphical user interface or a web browser through which a user can interact with embodiments of the systems and techniques described herein), or a computing system that includes any combination of such back-end component, middleware component or front-end component. Components of the system can be interconnected by any form or medium of digital data communication (for example, communication network). Examples of communication networks include local area network (LAN), wide area network (WAN) and Internet.

A computer system may include a client and a server. The client and server are generally far away from each other and usually interact through a communication network. The relationship between client and server may be generated by computer programs running on corresponding computers and having a client-server relationship with each other.

The above embodiments can be implemented in whole or in part by software, hardware, firmware or any combination thereof. When implemented in software, the embodiments can be fully or partially implemented in the form of a computer program product, the computer program product includes one or more computer programs or instructions. When the computer programs or instructions are loaded and executed on a computer, the processes or functions described in the embodiments of the present disclosure are fully or partially executed. The computer can be a general-purpose computer, a special-purpose computer, a computer network, a terminal, user equipment or other programmable devices. The computer programs or instructions can be stored in a computer-readable storage medium or transmitted from one computer-readable storage medium to another, for example, the computer programs or instructions can be transmitted from one website, computer, server or data center to another website, computer, server or data center by wired or wireless means. The computer-readable storage medium can be any available medium that a computer can access or a data storage device such as a server or a data center that integrates one or more available media. The available media can be magnetic media, such as floppy disk, hard disk, magnetic tape; can also be optical media, such as a digital video disc (DVD); can also be semiconductor media, for example, a solid state drive (SSD).

Although the present disclosure has been described in connection with specific features and embodiments thereof, it is obvious that various modifications and combinations can be made without departing from the spirit and scope of the present disclosure. Accordingly, the specification and drawings are merely illustrative of the present disclosure as defined by the appended claims, and are regarded as covering any and all modifications, variations, combinations or equivalents within the scope of the present disclosure. Obviously, those skilled in the art can make various modifications and variations to the present disclosure without departing from its spirit and scope. Therefore, if these modifications and variations of the present disclosure are within the scope of the claims of the present disclosure and their equivalents, the present disclosure is also intended to include them.

1. A method of constructing a gaze prediction model, the method comprising:
inputting a first eye sample image and a second eye sample image into an auxiliary prediction model to obtain gaze difference description information, wherein the gaze difference description information is configured to represent a gaze difference between the first eye sample image and the second eye sample image;
inputting the first eye sample image and the second eye sample image into the gaze prediction model to be constructed to obtain predicted gaze information, where the predicted gaze information comprises a first predicted gaze parameter of the first eye sample image and a second predicted gaze parameter of the second eye sample image;
determining a loss of the gaze prediction model to be constructed based on the gaze difference description information and the predicted gaze information;
in response to that the loss of the gaze prediction model to be constructed does not meet a convergence condition, updating model parameters of the gaze prediction model to be constructed based on the gaze difference description information and the predicted gaze information; and/or, in response to that the loss of the gaze prediction model to be constructed meets the convergence condition, determining the gaze prediction model to be constructed as the gaze prediction model.

2. The method according to claim 1, wherein the gaze difference description information comprises a first eye image feature and a reference gaze difference parameter, the predicted gaze information further comprises a second eye image feature, and the loss of the gaze prediction model to be constructed comprises a first loss parameter and a second loss parameter;
wherein, the first loss parameter is determined based on the first predicted gaze parameter, the second predicted gaze parameter and supervision information for the eye sample images, the supervision information for the eye sample images comprises the reference gaze difference parameter, and the second loss parameter is determined based on the first eye image feature and the second eye image feature.

3. The method according to claim 2, wherein the loss of the gaze prediction model to be constructed is determined based on a weighted result for the first loss parameter and the second loss parameter, and a weight for the second loss parameter is greater than a weight for the first loss parameter.

4. The method according to claim 2, wherein the first loss parameter comprises a first sub-loss parameter and a second sub-loss parameter;
the first sub-loss parameter is determined based on the reference gaze difference parameter and a gaze difference parameter, and the gaze difference parameter is determined based on a difference between a first predicted sight parameter and a second predicted sight parameter;
the supervision information for the eye sample images further comprises a first annotated gaze direction of the first eye sample image and a second annotated gaze direction of the second eye sample image, the second sub-loss parameter is determined based on the first predicted loss parameter and the second predicted loss parameter, the first predicted loss parameter is determined based on the first annotated gaze direction and the first predicted gaze parameter, the second predicted loss parameter is determined based on the second annotated gaze direction and the second predicted gaze parameter.

5. The method according to claim 1, wherein the method further comprises:
updating the model parameters of the auxiliary prediction model based on the reference gaze difference parameter and an annotated gaze difference parameter, and the annotated gaze difference parameter is determined based on the first annotated gaze direction and the second annotated gaze direction.

6. The method according to claim 2, wherein the predicted gaze information further comprises a predicted gaze difference parameter, and the loss of the gaze prediction model to be constructed further comprises a third loss parameter, and the third loss parameter is determined based on the predicted gaze difference parameter and the reference gaze difference parameter, and
wherein, the loss of the gaze prediction model to be constructed is determined based on a weighted result of the first loss parameter, the second loss parameter and the third loss parameter, and the weight for the first loss parameter and the weight for the third loss parameter are both smaller than the weight for the second loss parameter.

7. The method according to claim 1 wherein the method further comprises:
determining the annotated gaze difference parameter based on the first annotated gaze direction of the first eye sample image and the second annotated gaze direction of the second eye sample image;
calibrate the reference gaze difference parameter based on the annotated gaze difference parameter.

8. The method according to claim 2, wherein the auxiliary prediction model comprises a first backbone network, a first feature splicing network, and a first difference prediction network, and the gaze prediction model to be constructed comprises a second backbone network and a direction prediction network;
the first backbone network comprises a first basic module configured to output a first eye image feature, the first feature splicing network is configured to determine a first gaze splicing feature based on the first eye image feature, and the first difference prediction network is configured to determine the reference gaze difference parameter based on the first gaze splicing feature;
the second backbone network contains a second basic module configured to output a second eye image feature, and the direction prediction network is configured to determine the first predicted gaze parameter and the second predicted gaze parameter based on the second eye image feature.

9. The method according to claim 8, wherein the first backbone network contains multiple layers of first basic modules, and the second backbone network contains multiple layers of second basic modules, the first basic module corresponds to the second basic module in each layer, the second loss parameter is determined by the multiple layers of eye feature difference parameters, and the eye feature difference parameter in each layer is determined based on the first eye image feature output by the first basic module in the corresponding layer and the second eye image feature output by the second basic module in the corresponding layer.

10. The method according to claim 2, wherein in response to the predicted gaze information further comprising the predicted gaze difference parameter, the gaze prediction model to be constructed further comprises a second feature splicing network and a second difference prediction network, the second feature splicing network is configured to determine the second gaze splicing feature based on the second eye image feature, and the second difference prediction network is configured to determine the predicted gaze difference parameter based on the second gaze splicing feature.

11-15. (canceled)

16. An electronic device, comprising:
a processor;
a memory storing programs and/or instructions, wherein the programs and/or instructions, when executed by the processor, cause the processor to implement:
inputting a first eye sample image and a second eye sample image into an auxiliary prediction model to obtain gaze difference description information, wherein the gaze difference description information is configured to represent a gaze difference between the first eye sample image and the second eye sample image;
inputting the first eye sample image and the second eye sample image into the gaze prediction model to be constructed to obtain predicted gaze information, where the predicted gaze information comprises a first predicted gaze parameter of the first eye sample image and a second predicted gaze parameter of the second eye sample image;
determining a loss of the gaze prediction model to be constructed based on the gaze difference description information and the predicted gaze information;
in response to that the loss of the gaze prediction model to be constructed does not meet a convergence condition, updating model parameters of the gaze prediction model to be constructed based on the gaze difference description information and the predicted gaze information; and/or, in response to that the loss of the gaze prediction model to be constructed meets the convergence condition, determining the gaze prediction model to be constructed as the gaze prediction model.

17. A non-transitory computer-readable storage medium storing computer instructions which, when executed by a computer, cause the computer to implement:
inputting a first eye sample image and a second eye sample image into an auxiliary prediction model to obtain gaze difference description information, wherein the gaze difference description information is configured to represent a gaze difference between the first eye sample image and the second eye sample image;
inputting the first eye sample image and the second eye sample image into the gaze prediction model to be constructed to obtain predicted gaze information, where the predicted gaze information comprises a first predicted gaze parameter of the first eye sample image and a second predicted gaze parameter of the second eye sample image;
determining a loss of the gaze prediction model to be constructed based on the gaze difference description information and the predicted gaze information;
in response to that the loss of the gaze prediction model to be constructed does not meet a convergence condition, updating model parameters of the gaze prediction model to be constructed based on the gaze difference description information and the predicted gaze information; and/or, in response to that the loss of the gaze prediction model to be constructed meets the convergence condition, determining the gaze prediction model to be constructed as the gaze prediction model.

18-19. (canceled)

20. The electronic device according to claim 16, wherein the gaze difference description information comprises a first eye image feature and a reference gaze difference parameter, the predicted gaze information further comprises a second eye image feature, and the loss of the gaze prediction model to be constructed comprises a first loss parameter and a second loss parameter;
wherein, the first loss parameter is determined based on the first predicted gaze parameter, the second predicted gaze parameter and supervision information for the eye sample images, the supervision information for the eye sample images comprises the reference gaze difference parameter, and the second loss parameter is determined based on the first eye image feature and the second eye image feature,
wherein the loss of the gaze prediction model to be constructed is determined based on a weighted result for the first loss parameter and the second loss parameter, and a weight for the second loss parameter is greater than a weight for the first loss parameter.

21. The electronic device according to claim 20, wherein the first loss parameter comprises a first sub-loss parameter and a second sub-loss parameter;
the first sub-loss parameter is determined based on the reference gaze difference parameter and a gaze difference parameter, and the gaze difference parameter is determined based on a difference between a first predicted sight parameter and a second predicted sight parameter;
the supervision information for the eye sample images further comprises a first annotated gaze direction of the first eye sample image and a second annotated gaze direction of the second eye sample image, the second sub-loss parameter is determined based on the first predicted loss parameter and the second predicted loss parameter, the first predicted loss parameter is determined based on the first annotated gaze direction and the first predicted gaze parameter, the second predicted loss parameter is determined based on the second annotated gaze direction and the second predicted gaze parameter.

22. The electronic device according to claim 16, wherein the programs and/or instructions, when executed by the processor, cause the processor to:
update the model parameters of the auxiliary prediction model based on the reference gaze difference parameter and an annotated gaze difference parameter, and the annotated gaze difference parameter is determined based on the first annotated gaze direction and the second annotated gaze direction.

23. The electronic device according to claim 20, wherein the predicted gaze information further comprises a predicted gaze difference parameter, and the loss of the gaze prediction model to be constructed further comprises a third loss parameter, and the third loss parameter is determined based on the predicted gaze difference parameter and the reference gaze difference parameter, and
wherein, the loss of the gaze prediction model to be constructed is determined based on a weighted result of the first loss parameter, the second loss parameter and the third loss parameter, and the weight for the first loss parameter and the weight for the third loss parameter are both smaller than the weight for the second loss parameter.

24. The non-transitory computer-readable storage medium according to claim 17, wherein the gaze difference description information comprises a first eye image feature and a reference gaze difference parameter, the predicted gaze information further comprises a second eye image feature, and the loss of the gaze prediction model to be constructed comprises a first loss parameter and a second loss parameter;
wherein, the first loss parameter is determined based on the first predicted gaze parameter, the second predicted gaze parameter and supervision information for the eye sample images, the supervision information for the eye sample images comprises the reference gaze difference parameter, and the second loss parameter is determined based on the first eye image feature and the second eye image feature,
wherein the loss of the gaze prediction model to be constructed is determined based on a weighted result for the first loss parameter and the second loss parameter, and a weight for the second loss parameter is greater than a weight for the first loss parameter.

25. The non-transitory computer-readable storage medium according to claim 24, wherein the first loss parameter comprises a first sub-loss parameter and a second sub-loss parameter;
the first sub-loss parameter is determined based on the reference gaze difference parameter and a gaze difference parameter, and the gaze difference parameter is determined based on a difference between a first predicted sight parameter and a second predicted sight parameter;
the supervision information for the eye sample images further comprises a first annotated gaze direction of the first eye sample image and a second annotated gaze direction of the second eye sample image, the second sub-loss parameter is determined based on the first predicted loss parameter and the second predicted loss parameter, the first predicted loss parameter is determined based on the first annotated gaze direction and the first predicted gaze parameter, the second predicted loss parameter is determined based on the second annotated gaze direction and the second predicted gaze parameter.

26. The non-transitory computer-readable storage medium according to claim 17, wherein the computer instructions which, when executed by a computer, cause the computer to:
update the model parameters of the auxiliary prediction model based on the reference gaze difference parameter and an annotated gaze difference parameter, and the annotated gaze difference parameter is determined based on the first annotated gaze direction and the second annotated gaze direction.

27. The non-transitory computer-readable storage medium according to claim 24, wherein the predicted gaze information further comprises a predicted gaze difference parameter, and the loss of the gaze prediction model to be constructed further comprises a third loss parameter, and the third loss parameter is determined based on the predicted gaze difference parameter and the reference gaze difference parameter, and
wherein, the loss of the gaze prediction model to be constructed is determined based on a weighted result of the first loss parameter, the second loss parameter and the third loss parameter, and the weight for the first loss parameter and the weight for the third loss parameter are both smaller than the weight for the second loss parameter.
